(19) United States
(12) Patent Application Publication
(10) Pub. No.: US 2025/0392387 A1
(43) Pub. Date: Dec. 25, 2025

(54) APPARATUS AND METHOD FOR FULL DUPLEX MIMO OPTICAL COMMUNICATION

(71) Applicant: Electronics and Telecommunications Research Institute, Daejeon (KR)

(72) Inventors: Si Woong PARK, Daejeon (KR); HyoungJun PARK, Daejeon (KR); Chan Il YEO, Daejeon (KR); Young Soon HEO, Daejeon (KR)

(73) Assignee: Electronics and Telecommunications Research Institute, Daejeon (KR)

(21) Appl. No.: 19/037,450

(22) Filed: Jan. 27, 2025

(30) Foreign Application Priority Data
Jun. 19, 2024 (KR) 10-2024-0079549

(51) Int. Cl. H04B 10/11

(52) U.S. Cl. CPC H04B 10/11

(57) ABSTRACT

An optical communication apparatus according to one embodiment disclosed herein includes a first optical system unit and a second optical system unit that allow light of at least one first wavelength is transmitted into a free space and receive light of at least one second wavelength from the free space; and a modulation module that provides data which is transmitted to the first and second optical system units, wherein the first and second optical system units are arranged to control transmission/reception directions according to a communication target.

### CROSS-REFERENCE TO RELATED APPLICATION

This application claims priority to and the benefit of Korean Patent Application No. 10-2024-0079549, filed on Jun. 19, 2024, the disclosure of which is incorporated herein by reference in its entirety.

### BACKGROUND

### 1. Field of the Invention

Various embodiments disclosed herein relate to full-duplex multi-input multi-output (MIMO) optical communication technology.

### 2. Discussion of Related Art

Conventional systems have satellite performed inter-satellite communication using radio frequency (RF) communication. However, RF communication faces challenges in being applied to next-generation satellite communication technologies (e.g., space communication) due to limitations in communication range, communication bandwidth, and the constraints of size and power in satellite mounting environments.

To overcome these challenges, communication using laser light, which has high directivity and a narrow divergence angle, has emerged. Laser communication enables large-volume data transmission and long-range communication that are at least 10 to 1,000 times greater than RF communication, while reducing antenna size, weight, and power consumption to about 1/10.

Space laser communication technology is attracting attention as the most economical and effective method for data transmission in the space environment. Since the space environment is rarely affected by the atmospheric environment (e.g., light absorption and light scattering), optical loss is low, and thus the technology utilization is much higher than that of the Earth environment.

However, space laser communication technology uses a single-input single-output relay (SISO-Relay) method, which involves a single antenna. Therefore, communication distortion may occur due to limitations in the antenna's reception sensitivity and transmission power, and there are limitations in diversity in terms of building inter-satellite communication networks.

### SUMMARY OF THE INVENTION

The present disclosure is directed to providing an apparatus and method for full-duplex multi-input multi-output (MIMO) optical communication that may flexibly utilize multiple paths through a plurality of optical system units according to a communication target and data.

According to an aspect of the present embodiment, there is provided an optical communication apparatus including a first optical system unit and a second optical system unit that allow light of at least one first wavelength into a free space and receive light of at least one second wavelength from the free space; and a modulation module that provides data to be transmitted to the first and second optical system units, wherein the first and second optical system units are arranged to control transmission/reception directions according to a communication target.

According to another aspect of the present embodiment, there is provided an optical communication method, which is performed by an optical communication apparatus including a first optical system unit and a second optical system unit that allow light of at least one wavelength to be transmitted/received and controls transmission/reception directions thereof, the optical communication method including: identifying communication targets of the first and second optical system units; and controlling the transmission/reception directions of the first and second optical system units to be different directions according to the identified communication targets.

According to another aspect of the present embodiment, there is provided an optical communication apparatus including: a first optical system unit; a second optical system unit that transmits and receives an optical signal different from that of the first optical system unit; and a gimbal unit that controls an angle between the first and second optical system units according to a communication target.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view for describing direction control in a full-duplex multi-input multi-output (MIMO) optical communication apparatus according to one embodiment;

FIG. 2 shows a configuration diagram of an optical communication apparatus according to one embodiment;

FIG. 3 is an exemplary view illustrating an optical communication system that performs multiplex transmission/reception of first and second data through two optical system units according to one embodiment;

FIG. 4 is an exemplary view illustrating an optical communication apparatus that transmits or receives first to fourth data through respective optical system units according to one embodiment;

FIG. 5 is an exemplary view illustrating an optical communication apparatus that performs multiplex transmission of first data through two optical system units and receives second and fourth data through one optical system unit according to one embodiment;

FIG. 6 is an exemplary view illustrating an optical communication apparatus that performs multiplex transmission of first and third data through two optical system units and receives second data through two optical system units according to one embodiment;

FIGS. 7 and 8 illustrate a full-duplex space laser communication method of a multi-wavelength multiplexing-based MIMO structure in the case of two optical system units transmitting the same data;

FIGS. 9 and 10 illustrate a full-duplex space laser communication method of a multi-wavelength multiplexing-based MIMO structure in the case of two optical system units transmitting different data;

FIGS. 11 and 12 are views for describing a relay-type space laser communication method;

FIG. 13 is a flowchart of transmission/reception direction control by an optical communication apparatus according to one embodiment; and

FIG. 14 is a flowchart of a MIMO optical communication method according to one embodiment.

### DETAILED DESCRIPTION OF EXEMPLARY EMBODIMENTS

In relation to the description of the drawings, the same or similar reference numerals may be used for the same or similar components.

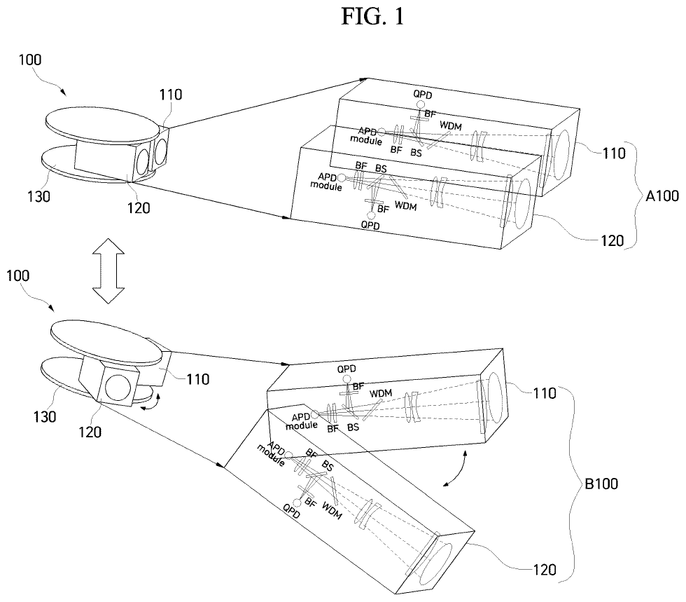

FIG. 1 is a view for describing direction control in a full-duplex multi-input multi-output (MIMO) optical communication apparatus according to one embodiment.

Referring to FIG. 1, a full-duplex MIMO optical communication apparatus 100 according to one embodiment may include a first optical system unit 110, a second optical system unit 120, and a gimbal unit 130.

In one embodiment, the first and second optical system units 110 and 120 may be configured to transmit light of a first wavelength and receive light of a second wavelength. The light of the first wavelength and the light of the second wavelength may each be laser light having a very narrow linewidth.

In one embodiment, the first and second optical system units 110 and 120 may transmit and receive the same data and may transmit and receive different data. For example, the first and second optical system units 110 and 120 may each transmit light of a first wavelength carrying the same first data and may each receive light of a second wavelength carrying the same second data. As another example, the first and second optical system units 110 and 120 may each transmit light of a first wavelength carrying different first and third data and may each receive light of a second wavelength carrying different second and fourth data.

In one embodiment, the first and second optical system units 110 and 120 may be configured to control their respective transmission/reception directions. For example, the first and second optical system units 110 and 120 may be fixed to the gimbal unit 130, and their transmission/reception directions may be controlled according to movement of the gimbal unit 130.

According to one embodiment, the gimbal unit 130 may fix parts of the first and second optical system units 110 and 120 and control the transmission/reception directions of the first and second optical system units 110 and 120 according to its movement. For example, the gimbal unit 130 may control the transmission/reception directions of the first and second optical system units 110 and 120 to be parallel to each other in a first mode for communication with a single communication target, such as the first state A100 of FIG. 1. As another example, the gimbal unit 130 may control the transmission/reception directions of the first and second optical system units 110 and 120 to be different directions in a second mode for communication with two communication targets, such as the second state B100 of FIG. 1. The first mode may be a data transmission/reception mode, and the second mode may be a mode for transmitting/receiving or relaying data.

In this way, the optical communication apparatus 100 according to one embodiment may increase the amount of data transmitted and received at one time by providing an optical communication system having a MIMO structure including a plurality of optical system units each capable of full-duplex communication.

In addition, the optical communication apparatus 100 according to one embodiment may control the transmission/reception directions of the plurality of optical system units 110 and 120 (or the angle between the plurality of optical system units 110 and 120). Thus, the optical communication apparatus 100 may operate in various modes for transmitting/receiving or relaying data with one or more optical communication apparatuses.

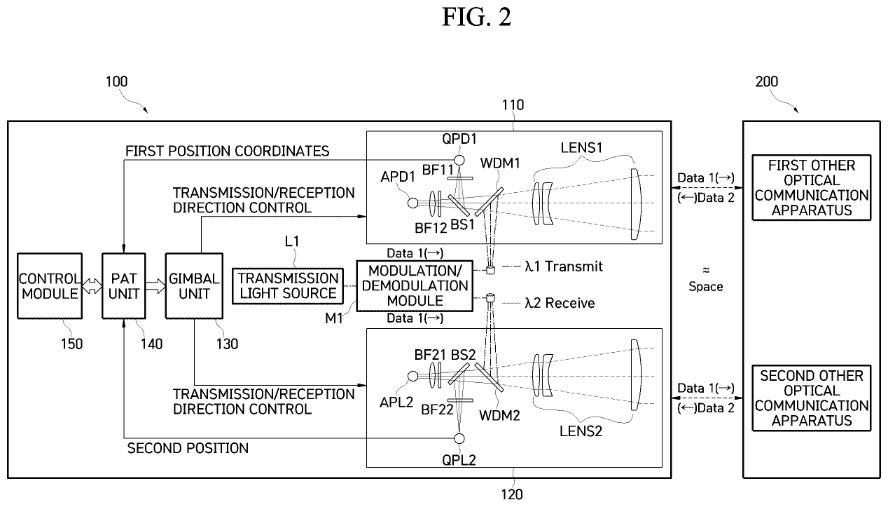

FIG. 2 shows a configuration diagram of the optical communication apparatus according to one embodiment.

Referring to FIG. 2, an optical communication apparatus 100 according to one embodiment may include a control module 150, a modulation/demodulation module M1, a first optical system unit 110, a second optical system unit 120, a gimbal unit 130, and a PAT unit 140. In one embodiment, some components of the optical communication apparatus 100 may be omitted, or additional components may be included. In addition, some of the components of the optical communication apparatus 100 may be combined to form a single entity while maintaining the same functions of the corresponding components before combining. For example, the gimbal unit 130 may be included in the PAT unit 140. In one embodiment, the optical communication apparatus 100 may be a space laser communication apparatus (laser-based satellite system).

The control module 150 may include at least one processor. The processor may control at least one other component of the optical communication apparatus 100 (e.g., the PAT unit 140, the gimbal unit 130) and perform various types of data processing or calculations. The processor may include, for example, at least one of a central processing unit (CPU), a graphics processing unit (GPU), a microprocessor, an application processor, an application specific integrated circuit (ASIC), and a field programmable gate array (FPGA), and may have multiple cores.

According to one embodiment, the control module 150 may generate transmission data according to a user input or provide (e.g., output) reception data to the user. The transmission data may be transmitted to a free space through at least one optical system unit among the first and second optical system units 110 and 120 by being carried on light of different wavelengths by the modulation/demodulation module M1. The reception data may be data demodulated through the modulation/demodulation module M1 after being received through the at least one optical system unit.

According to one embodiment, the control module 150 may check communication target information (e.g., direction information of another optical communication apparatus) based on a user input and generate a direction control signal of the gimbal unit 130 based on the communication target information. In this regard, the direction control signal may be transmitted to the gimbal unit 130, and the gimbal unit 130 may control the transmission/reception directions of the first and second optical system units 110 and 120 according to the direction control signal. In this case, the direction control signal may be transmitted to the gimbal unit 130 through the PAT unit 140.

According to one embodiment, when the modulation/demodulation module M1 obtains transmission data (e.g., Ethernet data) from the control module 150, the transmission data may be modulated and transmitted through at least one of the first and second optical system units 110 and 120 after carrying the data on the light of a first wavelength. When the modulation/demodulation module M1 obtains reception data carried on the light of the second wavelength from the at least one optical system unit, the modulation/demodulation module M1 may be separated the reception data from the light of the second wavelength and transmitted to the control module 150. In one embodiment, the control module 150 and the modulation/demodulation module M1 may be connected through Ethernet communication and may transmit and receive Ethernet data. However, it is not limited thereto.

In one embodiment, the modulation/demodulation module M1 may include a first modulator that modulates transmission light to be transmitted to the first optical system unit 110 and a first demodulator that demodulates the light obtained from the first optical system unit 110. The modulation/demodulation module M1 may include a second modulator that modulates transmission light to be transmitted to the second optical system unit 120 and a second demodulator that demodulates the light obtained from the second optical system unit 120. The modulation/demodulation module M1 may respectively be included in the first and second optical system units 110 and 120.

According to one embodiment, the first optical system unit 110 may be configured to transmit light of a first wavelength λ1 and receive light of a second wavelength λ2. The first optical system unit 110 may include at least some of a transmission light source L1, a first multiplexing (wavelength division multiplexing) filter WDM1, a first optical splitter BS1, a first position recognition sensor QPD1, first block filters BF11 and BF12, a first photodetector APD1, and a first lens unit LENS1. In one embodiment, the first optical system unit 110 may further include a part of the modulation/demodulation module M1. However, for convenience of explanation in this document, an example in which the modulation/demodulation module M1 is formed separately from the first optical system unit 110 will be described.

According to one embodiment, at least part of the transmission light source L1 may generate laser light (hereinafter, referred to as “light of the first wavelength”) to be transmitted and transmit the laser light to the first part (the first modulator) of the modulation/demodulation module M1. The first part (e.g., the first modulator) of the modulation/demodulation module M1 may carry transmission data on the light of the first wavelength and transmit the transmission data to the first multiplexing filter WDM1.

According to one embodiment, the first multiplexing filter WDM1 may separate light of different transmission/reception wavelengths, for example, the light of the first wavelength to be transmitted and the received light of the second wavelength. The first multiplexing filter WDM1 reflects the light of the transmission wavelength (the first wavelength) in a first direction toward the first lens unit LENS1, and as a result, the light of the first wavelength may be output into a free space through the first lens unit LENS1. The first multiplexing filter WDM1 transmits the light of the reception wavelength (second wavelength) from the free space through the first lens unit LENS1 and transmits the light of the reception wavelength to the first optical splitter BS1.

According to one embodiment, the first optical splitter BS1 may transmit some of the light of the reception wavelength in a second direction toward the first position recognition sensor QPD1 and branch the rest of the light of the reception wavelength in a third direction toward the first photodetector APD1 by splitting the light of the reception wavelength.

According to one embodiment, the first position recognition sensor QPD1 may obtain some of the light of the reception wavelength branched by the first optical splitter BS1 through a 1-1 block filter BF11. The first position recognition sensor QPD1 may recognize the position coordinates of the received light in order to perform tracking and perform line-of-sight alignment of a first other optical communication apparatus 200_1 (counterpart system).

According to one embodiment, the first photodetector APD1 may receive light of a reception wavelength (second wavelength) through a 1-2 block filter BF12, detect a signal from the reception light, and then convert the detected signal into an electrical signal. The first photodetector APD1 may be equipped with an avalanche photodiode (APD) to sensitively receive data at gigabit speeds or higher.

The 1-1 and 1-2 block filters BF11 and BF12 may each block the light of an unwanted wavelength. At least one of the 1-1 and 1-2 block filters BF11 and BF12 may be omitted in some cases. In this case, the first lens unit LENS1 may be provided differently. For example, the number of lenses included in the first lens unit LENS1 may vary.

According to one embodiment, the second optical system unit 120 may be configured to transmit light of a first wavelength λ1 and receive light of a second wavelength λ2. The second optical system unit 120 may include the at least remaining part of the transmission light source L1, a second multiplexing filter WDM2, a second light splitter BS2, a second position recognition sensor QPD2, second block filters BF21 and BF22, a second photodetector APD2, and a second lens unit LENS2.

In one embodiment, the second optical system unit 120 may further include the at least remaining part of the modulation/demodulation module M1. However, for convenience of explanation in this document, an example in which the modulation/demodulation module M1 is formed separately from the second optical system unit 120 will be described.

The remaining part of the transmission light source L1 may generate laser light (hereinafter, referred to as “light of the first wavelength”) to be transmitted through the second optical system unit 120 and transmit the laser light to the second part (second modulator) of the modulation/demodulation module M1. The second part (e.g., second modulator) of the modulation/demodulation module M1 may carry transmission data on the light of the first wavelength and transmit the transmission data to the second multiplexing filter WDM2.

The second multiplexing filter WDM2 may separate the light of different transmission/reception wavelengths, for example, the received light of the second wavelength and the light of the first wavelength to be transmitted. The second multiplexing filter WDM2 reflects the light of the transmission wavelength (the first wavelength) in a fourth direction toward the second lens unit LENS2, and as a result, light of the first wavelength may be output into a free space through the second lens unit LENS2. In addition, the second multiplexing filter WDM2 transmits the received light of the wavelength (the second wavelength) from the free space through the second lens unit LENS2 and transmits the received light of the wavelength to the second light splitter BS2.

The second light splitter BS2 may transmit some of the light of the reception wavelength (the second wavelength) in a fifth direction toward the second position recognition sensor QPD2 by splitting the light of the reception wavelength and may branch the rest of the light of the reception wavelength in a sixth direction toward the second photodetector APD2.

The second position recognition sensor QPD2 may obtain some of the light of the reception wavelength (the first wavelength) split by the second light splitter BS2 through a 2-1 block filter BF21. The second position recognition sensor QPD2 may recognize the position coordinates of the received light to perform tracking and line-of-sight alignment of a second other optical communication apparatus 200_2 (counterpart system).

The second photodetector APD2 may receive the light of the reception wavelength (the second wavelength) through a 2-2 block filter BF22, detect a signal from the reception light, and then convert the detected signal into an electrical signal. The second photodetector APD2 may include an avalanche photodiode (APD) to sensitively receive data at gigabit speeds or higher.

The 2-1 and 2-2 block filters BF21 and BF22 may each block the light of an unwanted wavelength. For example, the 2-1 and 2-2 block filters BF21 and BF22 may transmit the light of the reception wavelength (the first wavelength) and block the light of other wavelengths. At least one of the 2-1 and 2-2 block filters BF21 and BF22 may be excluded in some cases. In this case, the second lens unit LENS2 may be provided differently. For example, the number of lenses included in the second lens unit LENS2 may vary.

According to one embodiment, the PAT unit 140 may obtain the first position coordinates of the light received by the first optical system unit 110 from the first position recognition sensor QPD1. The PAT unit 140 may track the first other optical communication apparatus 200_1 communicating through the first optical system unit 110 based on the first position coordinates. The PAT unit 140 may finely control the transmission/reception directions (angle) of the first optical system unit 110 so that the incident light with respect to the origin of the first position recognition sensor QPD1 is maximized.

In addition, the PAT unit 140 may obtain the second position coordinates of the light received by the second optical system unit 120 from the second position recognition sensor QPD2. The PAT unit 140 may track the second other optical communication apparatus 200_2 communicating through the second optical system unit 120 based on the second position coordinates. The PAT unit 140 may control the transmission/reception directions (angle) of the second optical system unit 120 so that the incident light with respect to the origin of the second position recognition sensor QPD2 is maximized.

In addition, the PAT unit 140 may check the amount of light detected by each of the first and second photodetectors APD1 and APD2 and finely control the angles of the first and second lens units LENS1 and LENS2 (or the transmission/reception directions of the first and second optical system units 110 and 120) so that the detected optical power is maximized.

According to one embodiment, the gimbal unit 130 may control the transmission/reception directions of the first and second optical system units 110 and 120. For example, the gimbal unit 130 may obtain a control signal related to the control of the transmission/reception directions of the optical system units 110 and 120 from at least one module of the control module 150 and the PAT unit 140, and may control the transmission/reception directions of the first and second optical system units 110 and 120 according to the obtained control signal. As another example, the gimbal unit 130 may obtain a direction control signal from the control module 150 and may control the transmission/reception directions of the first and second optical system units 110 and 120 to be a default direction (e.g., 0 degrees or 45 degrees) according to the direction control signal obtained before data transmission. Thereafter, the gimbal unit 130 may finely control the transmission/reception directions of the first and second optical system units 110 and 120 (or perform line-of-sight alignment) according to the control signal of the PAT unit 140.

In one embodiment, the gimbal unit 130 may control the transmission/reception directions of the first and second optical system units 110 and 120 to be substantially parallel (e.g., within an angle of 20 degrees) in a first mode in which the first and second optical system units 110 and 120 communicate with a single communication target (e.g., a first optical communication apparatus). Alternatively, the gimbal unit 130 may control the transmission/reception directions of the first and second optical system units 110 and 120 to different directions (e.g., 45 degrees) in a second mode in which the first and second optical system units 110 and 120 communicate with a plurality of communication targets (e.g., first and second other optical communication apparatuses 200_1 and 200_2).

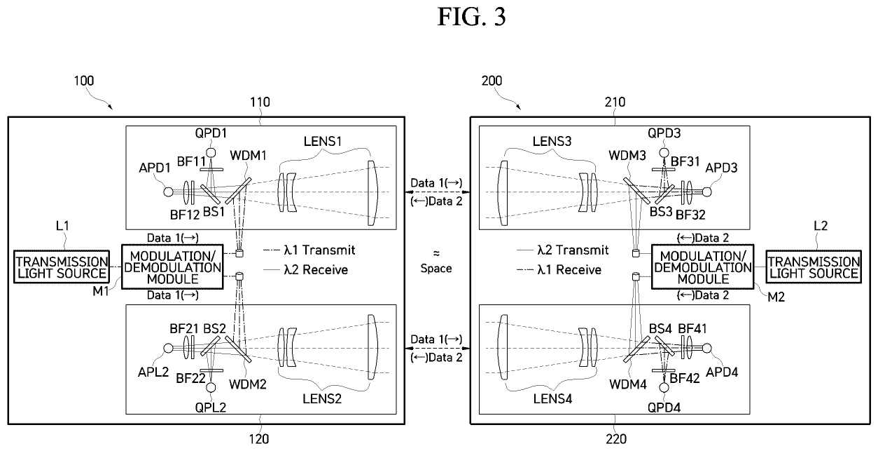

According to one embodiment, the first and second optical system units 110 and 120 may transmit and receive the same data or different data. This will be described below with reference to FIGS. 3 to 10.

According to various embodiments, the optical communication apparatus 100 may further include three or more optical system units, and the number of optical system units to be used for transmission of each piece of data or the transmission/reception directions may be controlled differently according to the type and volume of data to be transmitted, and the number of communication targets.

In this way, the optical communication apparatus 100 according to one embodiment includes a plurality of optical system units capable of controlling the transmission/reception direction and may relay data of one optical communication apparatus to another optical communication apparatus or transmit/receive data with the optical communication apparatus by controlling the transmission/reception directions of at least one optical system unit.

In addition, the optical communication apparatus 100 according to one embodiment may communicate in various ways to increase the transmission capacity, reduce the transmission error rate, or improve the reception sensitivity depending on the data transmission amount, type, and number of wavelengths.

FIG. 3 is an exemplary view illustrating an optical communication system that performs multiplex transmission/reception of first and second data through two optical system units according to one embodiment.

Referring to FIG. 3, the first optical communication apparatus 100 (e.g., the optical communication apparatus 100 of FIG. 2) may transmit first data (Data 1) to the two optical system units of the second optical communication apparatus 100 through the two optical system units 110 and 120 after carrying the first data on light of the first wavelength λ1 through the first modulation/demodulation module M1. Conversely, the second optical communication apparatus 200 may transmit second data (Data 2) to the two optical system units 110 and 120 of the first optical communication apparatus 100 through the two optical system units 210 and 220 after carrying the second data on light of the second wavelength λ2 through the modulation/demodulation module M2.

In this way, when the optical communication systems 100 and 200 according to one embodiment transmit the same data through two or more transmission/reception paths (optical system units), even when one path is blocked or damaged, the data may be transmitted through another path, and an error occurring in one path may be corrected using a signal from the other path. Thus, it is possible to improve the overall reliability and robustness of the system and reduce the data transmission error rate.

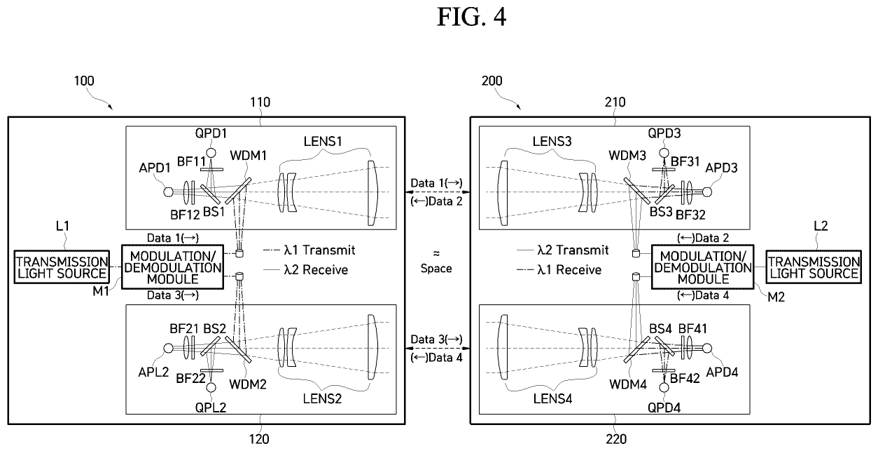

FIG. 4 is an exemplary view illustrating an optical communication apparatus transmitting or receiving first to fourth data through respective optical system units according to one embodiment.

Referring to FIG. 4, the first optical communication apparatus 100 (e.g., the optical communication apparatus 100 of FIG. 2) may transmit first data (Data 1) and third data (Data 3) to two optical system units 210 and 220 of the second optical communication apparatus 200 through two optical system units 110 and 120 by respectively carrying the first data and the third data on light of the first wavelength λ1 through the first modulation/demodulation module M1. Conversely, the second optical communication apparatus 200 may transmit second data (Data 2) and fourth data (Data 4) to two optical system units 110 and 120 of the first optical communication apparatus 100 by respectively carrying the second data and the fourth data on light of the second wavelength λ2 through the modulation/demodulation module M2.

In this way, when the optical communication systems 100 and 200 according to one embodiment transmit two or more different types of data through two or more transmission/reception paths, the channel capacity of the system may be significantly increased by transmitting more data using the same bandwidth. In addition, the optical communication systems 100 and 200 according to one embodiment may utilize frequency resources more efficiently and improve the overall performance and efficiency of the network.

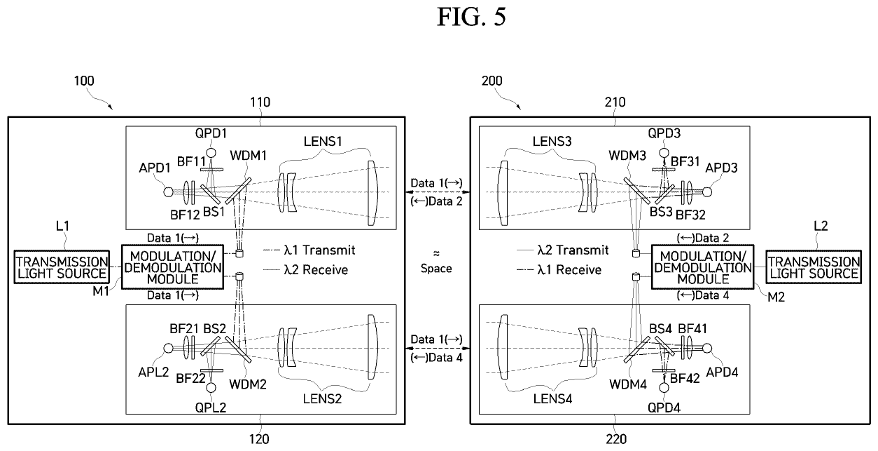

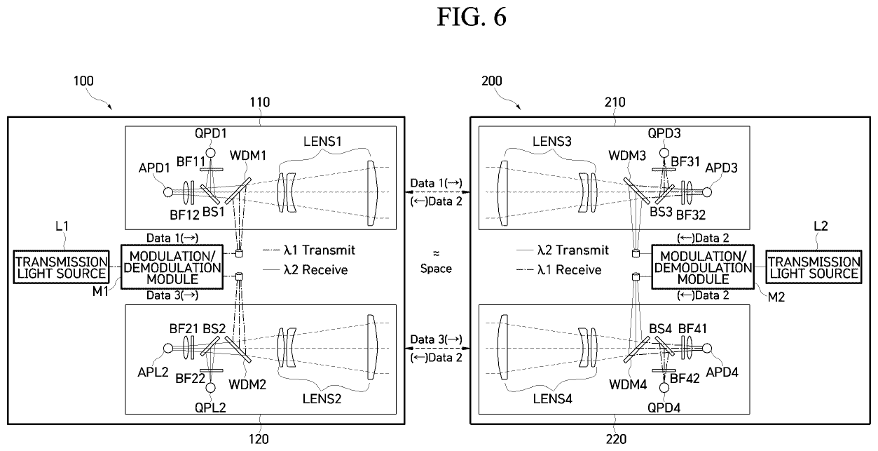

FIG. 5 is an exemplary view illustrating an optical communication apparatus that performs multiplex transmission of first data through two optical system units and receives second and fourth data through one optical system unit according to one embodiment. FIG. 6 is an exemplary view illustrating an optical communication apparatus that performs multiplex transmission of first and third data through two optical system units and receives second data through two optical system units according to one embodiment.

Referring to FIG. 5, the first optical communication apparatus 100 (e.g., the optical communication apparatus 100 of FIG. 2) may transmit first data (Data 1) to two optical system units 210 and 220 of the second optical communication apparatus 200 through two optical system units 110 and 120 by carrying the first data (Data 1) on light of the first wavelength λ1 through the first modulation/demodulation module M1. Conversely, the second optical communication apparatus 200 may transmit second data (Data 2) and fourth data (Data 4) to two optical system units 110 and 120 of the first optical communication apparatus 100 through the two optical system units 210 and 220 by respectively carrying the second data and the fourth data on light of the second wavelength λ2 through the second modulation/demodulation module M2.

Referring to FIG. 6, the first optical communication apparatus 100 (e.g., the optical communication apparatus 100 of FIG. 2) may transmit first data (Data 1) and third data (Data 3) to two optical system units 210 and 220 of the second optical communication apparatus 200 through two optical system units 110 and 120 by respectively carrying the first data and the third data on light of the first wavelength λ1 through the first modulation/demodulation module M1. Conversely, the second optical communication apparatus 200 may transmit second data (Data 2) to two optical system units 110 and 120 of the first optical communication apparatus 100 through two optical system units 210 and 220 by carrying the second data on light of the second wavelength λ2 through the second modulation/demodulation module M2.

In this way, the optical communication systems 100 and 200 according to one embodiment may provide various cases according to the MIMO data transmission method, and thus the optical communication systems 100 and 200 may be flexibly provided to suit various environments and user requirements. Additionally, the number of transceivers (optical system units) and the number of data types (the number of data types to be transmitted/received) may be controlled as needed to optimize the performance of the system.

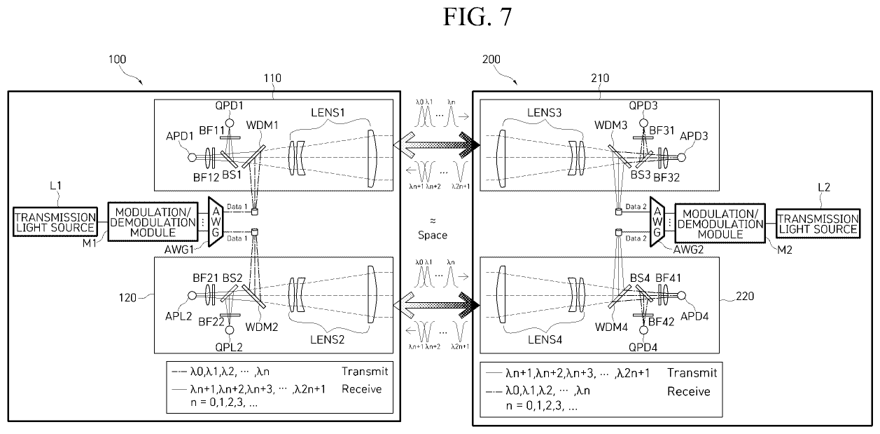

Hereinafter, a full-duplex space laser communication method of a multi-wavelength multiplexing-based MIMO structure according to one embodiment will be described with reference to FIGS. 7 to 10.

Referring to FIGS. 7 to 10, the optical communication apparatus 100 according to one embodiment may further include at least one arrayed waveguide grating AWG1 (hereinafter, referred to as ‘AWG’) capable of multi-wavelength coupling and distribution.

According to one embodiment, each AWG AWG1 acquires light having multiple wavelengths from the modulation/demodulation module M1, transmits the light of each wavelength to an arrayed waveguide, and combines the light of each wavelength passing through the arrayed waveguide into one optical fiber, thereby outputting multi-wavelength light. The multi-wavelength transmission light may be redirected through respective multiplexing filters WDM1 and WMD2 and output into a free space through respective lens units LENS1 and LENS2. Similarly, when light having multiple wavelengths passes through the free space and the optical system units 110 and 120 and is incident on one optical fiber in each AWG AWG1, the light may be distributed by wavelength through the arrayed waveguide of the AWG AWG1 and output as light of individual wavelengths through the arrayed optical fibers of the AWG AWG1. In this way, the optical communication systems 100 and 200 may improve the transmission capacity and efficiency of the space laser communication network while reducing signal interference by transmitting data simultaneously using multiple wavelengths through multiplexing using the AWG AWG1.

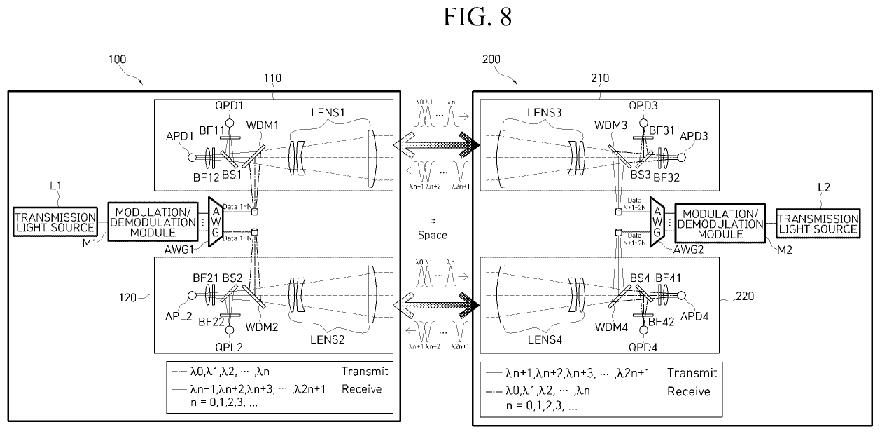

FIGS. 7 and 8 show a full-duplex space laser communication method of a multi-wavelength multiplexing-based MIMO structure in the case of two optical system units transmitting the same data.

First, in the case of FIG. 7, each optical system unit transmits the same large-volume data. For example, when two optical system units 110 and 120 of a first optical communication apparatus 100′ transmit light of multiple wavelengths such as λ0, λ1, λ2, . . . , and λn, the two optical system units 110 and 120 may carry first large-volume data (Data 1) and transmit the first large-volume data to two optical system units 210 and 220 of a second optical communication apparatus 200′ through the first modulation/demodulation module M1 and the first AWG AWG1. Conversely, when the two optical system units 210 and 220 of the second optical communication apparatus 200′ transmit light of multiple wavelengths such as λn+1, λn+2, λn+3, . . . , and λ2n+1, the two optical system units 210 and 220 on the right may carry the same second large-volume data (Data 2) and transmit the same second large-volume data to the two optical system units 110 and 120 of the first optical communication apparatus 100′ through the second modulation/demodulation module M2 and the second AWG AWG2.

Next, in the case of FIG. 8, the first and second optical communication apparatuses 100′ and 200′ transmit the same series of data over multiple wavelength bands. When two optical system units 110 and 120 of the first optical communication apparatus 100′ transmit light of multiple wavelengths such as λ0, λ1, λ2, . . . , and λn, the two optical system units 110 and 120 may each carry a first set of data (Data 1 to Data N) through the first modulation/demodulation module M1 and the first AWG AWG1 and transmit the first set of data to two optical system units 210 and 220 of the second optical communication apparatus 200′. Conversely, when the two optical system units 210 and 220 of the second optical communication apparatus 200′ transmit light of multiple wavelengths such as λn+1, λn+2, λn+3, . . . , and λ2n+1, the two optical system units 210 and 220 may each carry a second set of data (Data N+1 to Data 2N) through the second modulation/demodulation module M2 and the second AWG AWG2 and transmit the second set of data to the two optical system units 110 and 120 of the first optical communication apparatus 100′.

As shown in FIGS. 7 and 8, the optical communication systems 100′ and 200′ of the multi-wavelength multiplexing-based MIMO structure may transmit the same large-volume data through two or more transmission/reception paths similarly to FIG. 3. Therefore, even when one path is blocked or damaged, data may be transmitted through another path, and an error occurring in one of the multiple paths may be corrected using signals from the other path. Therefore, it is possible to improve the overall reliability and robustness of the system and reduce the data transmission error rate.

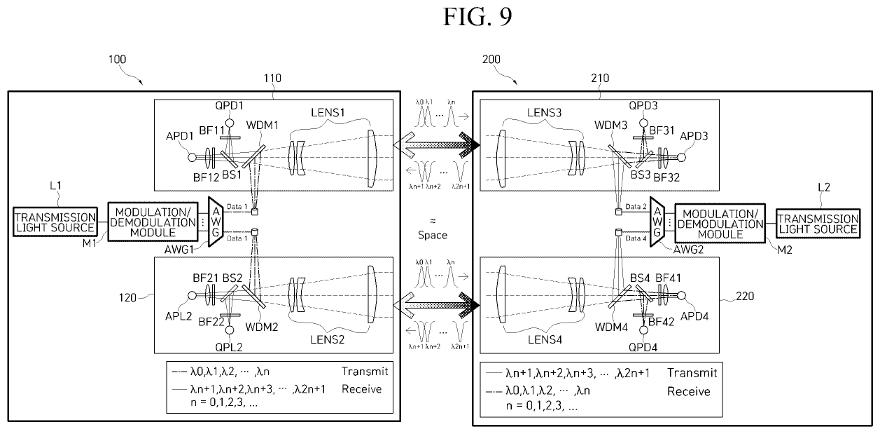

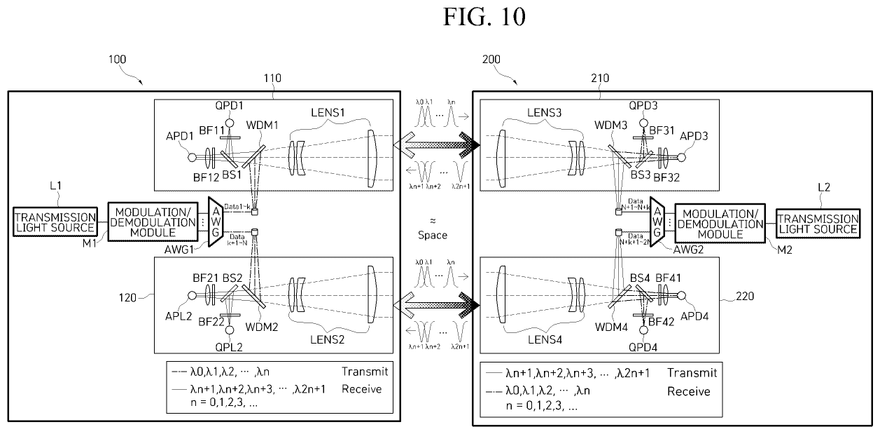

FIGS. 9 and 10 illustrate a full-duplex space laser communication method of a multi-wavelength multiplexing-based MIMO structure in the case of two optical system units transmitting different data.

FIG. 9 illustrates a case where the optical system units 110 and 120 or 210 and 220 transmit different large-volume data. For example, when two optical system units 110 and 120 of the first optical communication apparatus 100′ transmit light of multiple wavelengths such as λ0, λ1, λ2, . . . , and λn, different first large-volume data (Data 1) and third large-volume data (Data 3) transmitted through the first modulation/demodulation module M1 and the first AWG AWG1 may be carried on the light of λ0, λ1, λ2, . . . , and An and transmitted to two optical system units 210 and 220 of the second optical communication apparatus 200′.

Conversely, when two optical system units 210 and 220 of the second optical communication apparatus 200′ transmit light of multiple wavelengths such as λn+1, λn+2, λn+3, . . . , and λ2n+1, different second large-volume data (Data 2) and fourth large-volume data (Data 4) may be carried on the light of λn+1, λn+2, λn+3, . . . , and λ2n+1 and transmitted to two optical system units 110 and 120 of the first optical communication apparatus 100′ through the second modulation/demodulation module M2 and the second AWG AWG2.

In the case of FIG. 10, the optical system units 110 and 120 or 210 and 220 transmit a series of data after carrying the series of data in various wavelength bands. For example, when two optical system units 110 and 120 of the first optical communication apparatus 100′ transmit light of multiple wavelengths such as λ0, λ1, λ2, . . . , and λn, the first series of data (Data 1 to Data k) and the second series of data (Data k+1 to Data N) may be carried on the multi-wavelength light through the first modulation/demodulation module M1 and the first AWG AWG1, respectively, and transmitted to the two optical system units 210 and 220 of the second optical communication apparatus 200′. Conversely, when the two optical system units 210 and 220 of the second optical communication apparatus 200′ transmit light of multiple wavelengths such as λn+1, λn+2, λn+3, . . . , and λ2n+1, the third series of data (Data N+1 to Data N+k) and the fourth series of data (Data N+k+1 to Data 2N) may be carried on the multi-wavelength light through the first modulation/demodulation module M2 and the second AWG AWG2 and transmitted to the two optical system units 110 and 120 of the first optical communication apparatus 100′.

Referring to FIGS. 9 and 10, the optical communication systems 100 and 200 of the multi-wavelength multiplexing-based MIMO structure may transmit more data using the same bandwidth by transmitting two or more types of different data through two or more transmission/reception paths, similarly to FIG. 4, and thus may significantly increase the channel capacity of the system.

In addition, the optical communication systems 100′ and 200′ of the multi-wavelength multiplexing-based MIMO structure may utilize frequency resources more efficiently by simultaneously transmitting and receiving data and thus may improve the overall performance and efficiency of the network.

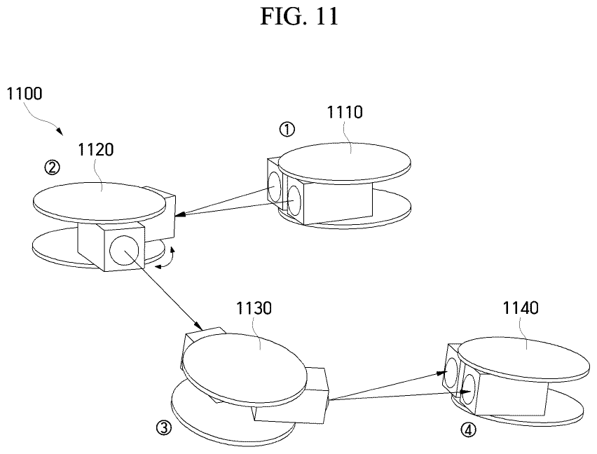

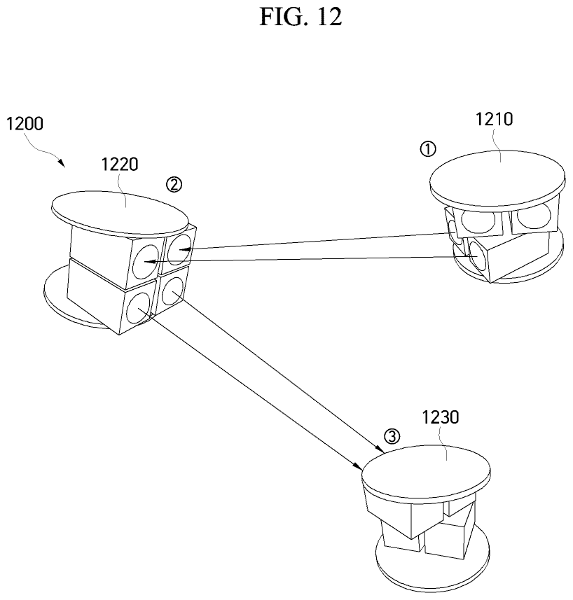

FIGS. 11 and 12 are views for describing a relay-type space laser communication method.

Referring to FIG. 11, an optical communication system 1100 according to one embodiment may include first to fourth optical communication apparatuses 1110, 1120, 1130, and 1140, each formed as a 2×2 MIMO structure. In FIG. 11, transmission data may be transmitted from a first optical communication apparatus 1110, which is a source, relayed by a second optical communication apparatus 1120 and a third optical communication apparatus 1130, and then transmitted to a fourth optical communication apparatus 1140, which is a destination.

In operation \textcircled{1}, the first optical communication apparatus 1110 may transmit transmission data using two optical system units. In operation \textcircled{2}, the second optical communication apparatus 1120 may receive data from the first optical communication apparatus 1110 using one optical system unit and transmit data to the third optical communication apparatus 1130 using the other optical system unit. In operation \textcircled{3}, the third optical communication apparatus 1130 may also receive data from the second optical communication apparatus 1120 using one optical system unit and transmit data to the fourth optical communication apparatus 1140 using the other optical system unit. In operation \textcircled{4}, the fourth optical communication apparatus 1140 may receive data from the other optical system unit of the third optical communication apparatus 1130 using two optical system units.

In this way, the optical communication system 1100 according to one embodiment may form an optical communication link with a hybrid structure of a single input single output (SISO)-based repeater (e.g., the second and third optical communication apparatuses 1120 and 1130) and a MIMO-based repeater (e.g., the first and fourth optical communication apparatuses 1110 and 1140).

As shown in FIG. 12, the optical communication system 1200 according to one embodiment may include first to third optical communication apparatuses 1210, 1220, and 1230, each formed as a 4×4 MIMO structure.

In operation \textcircled{1}, the first optical communication apparatus 1210 may transmit data to two upper optical system units of the second optical communication apparatus 1220 using two lower optical system units. In operation \textcircled{2}, the second optical communication apparatus 1220 may receive data using two upper optical system units and transmit data to two upper optical system units of the third optical communication apparatus 1230 using two lower optical system units. In operation \textcircled{3}, the third optical communication apparatus 1230 may receive data from the second optical communication apparatus 1220 using two upper optical system units.

As shown in FIG. 12, the optical communication system 1200 according to one embodiment may form an optical communication link with a MIMO structure as a whole.

In the embodiment of FIG. 12, the optical communication system 1200 according to one embodiment may relay the same data or transmit the result data of the operation performed based on the received data. For example, the first optical communication apparatus 1210 may instruct the second optical communication apparatus 1220 to measure the surrounding environment and transmit the result to the third optical communication apparatus 1230. In this case, the second optical communication apparatus 1220 may measure the surrounding environment and transmit the measurement result to the third optical communication apparatus 1230.

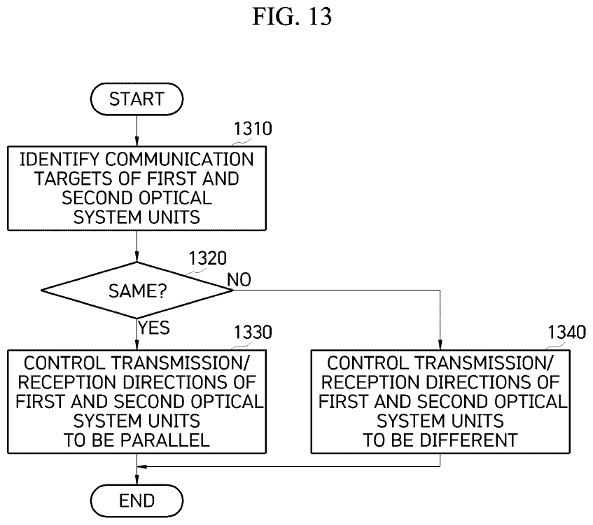

FIG. 13 is a flowchart of transmission/reception direction control by an optical communication apparatus according to one embodiment.

Referring to FIG. 13, in operation 1310, the optical communication apparatus 100 may identify the communication target of the first and second optical system units 110 and 120. For example, the optical communication apparatus 100 may identify the communication target (or direction information of the communication target) based on a user input.

In operation 1320, the optical communication apparatus 100 may check whether the communication targets of the first and second optical system units 110 and 120 are the same.

In operation 1320, when it is confirmed that the communication targets are the same, the optical communication apparatus 100 may control the transmission/reception directions of the first and second optical system units 110 and 120 to be parallel to each other in operation 1330.

In operation 1320, when it is confirmed that the communication targets do not match, the optical communication apparatus 100 may control the transmission/reception directions of the first and second optical system units 110 and 120 to be different directions in operation 1340.

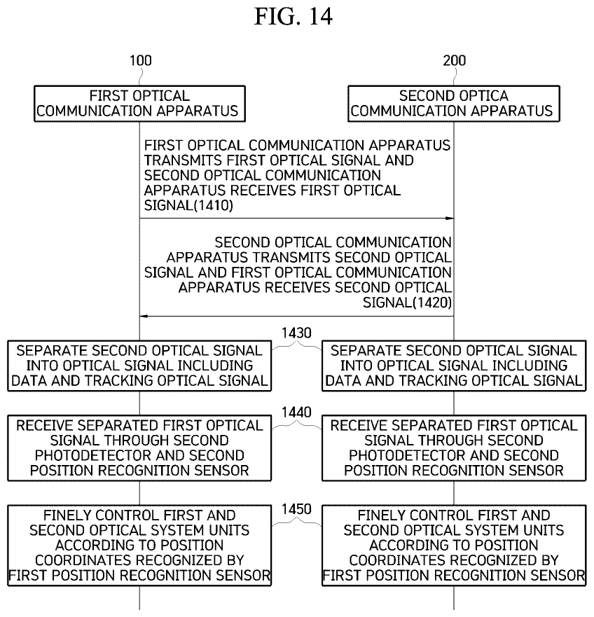

FIG. 14 is a flowchart illustrating a MIMO optical communication method according to one embodiment.

Referring to FIG. 14, in operation 1410, the first optical communication apparatus 100 may transmit a first optical signal, and the second optical communication apparatus 200 may receive the first optical signal.

In operation 1420, the second optical communication apparatus 200 may transmit a second optical signal, and the first optical communication apparatus 100 may receive the second optical signal. Operations 1410 and 1420 may be performed sequentially or in reverse order or may be performed simultaneously.

In operation 1430, the first optical communication apparatus 100 may separate the second optical signal received from the second optical communication apparatus 200 into an optical signal including data and an optical signal for tracking through the first multiplexing filter WDM1. At the same time, or separately, the second optical communication apparatus 200 may separate the first optical signal into an optical signal including data and an optical signal for tracking through the second multiplexing filter WDM2.

In operation 1440, the first optical communication apparatus 100 may receive the separated second optical signals through each of the first photodetector APD1 and the first position recognition sensor QPD1. At the same time, or separately, the second optical communication apparatus 200 may receive the separated first optical signals through each of the second photodetector APD2 and the second position recognition sensor QPD2.

In operation 1450, the first optical communication apparatus 100 may finely control the transmission/reception directions of the first and second optical system units 110 and 120 according to the position coordinates recognized by the first position recognition sensor QPD1. At the same time, or separately, the second optical communication apparatus 200 may finely control the transmission/reception directions of the third and fourth optical system units 210 and 220 according to the position coordinates recognized by the second position recognition sensor QPD2.

In this way, the first and second optical communication apparatuses 100 and 200 according to one embodiment may perform full-duplex MIMO communication using a plurality of optical system units.

According to various embodiments disclosed herein, multiple paths through a plurality of optical system units can be flexibly utilized according to the communication target and data. In addition, various effects that are directly or indirectly understood through this document may be provided.

It should be appreciated that various embodiments of the present disclosure and terms used therein are not intended to limit the technical features set forth herein to particular embodiments and include various changes, equivalents, or replacements for the corresponding embodiments. With regard to the description of the drawings, similar reference numerals may be used to refer to similar or related elements. It is to be understood that a singular form of a noun corresponding to an item may include one or more of the items, unless the context clearly indicates otherwise. As used herein, each of the phrases such as “A or B,” “at least one of A and B,” “at least one of A or B,” “A, B, or C,” “at least one of A, B, and C,” and “at least one of A, B, or C,” may include any one of the items enumerated together in the corresponding phrase, or all possible combinations. As used herein, terms such as “1^{st},” “2^{nd},” “first,” and “second” may be used simply to distinguish a corresponding component from another, and do not limit the components in other aspects (e.g., importance or order). When an element (e.g., a first element) is referred to as being “coupled” or “connected” to another element (e.g., a second element) with or without the term “operatively” or “communicatively,” it means that the element may be connected to the other element directly (e.g., in a wired manner), wirelessly or through a third element.

As used herein, the term “module” may include a unit implemented in hardware, software, or firmware, and may be used interchangeably with other terms such as “logic,” “logic block,” “part,” or “circuit.” A module may be a single integral component or a minimum unit or part thereof that perform one or more functions. For example, according to an embodiment, the module may be implemented in the form of an ASIC.

Various embodiments as set forth herein may be implemented as software (e.g., a program) including one or more instructions that are stored in a storage medium (e.g., a memory connected to the control module 150) (e.g., an internal memory or an external memory) that is readable by a machine (e.g., an optical communication apparatus). For example, a processor (e.g., a processor (e.g., the control module 150)) of the machine (e.g., the optical communication apparatus 100) may call at least one of the one or more instructions stored in the storage medium, and execute the at least one. This allows the machine to be operated to perform at least one function according to the at least one instruction called. The one or more instructions may include code generated by a complier or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), and this term does not differentiate between a case where data is semi-permanently stored in the storage medium and a case where the data is temporarily stored in the storage medium.

According to an embodiment, a method according to various embodiments of the present disclosure may be included and provided in a computer program product. The computer program product may be traded as a product between a seller and a buyer. The computer program product may be distributed in the form of a machine-readable storage medium (e.g., compact disc read only memory (CD-ROM)), or may be distributed (e.g., downloaded or uploaded) online through an application store (e.g., PlayStore™), or between two user devices (e.g., smart phones) directly. When distributed online, at least part of the computer program product may be temporarily generated or at least temporarily stored in the machine-readable storage medium, such as a memory of the manufacturer's server, a server of the application store, or a relay server.

The components according to various embodiments of this document may be implemented in the form of software or hardware such as a digital signal processor (DSP), an FPGA), or an ASIC, and may perform certain roles. The term “components” is not limited to software or hardware, and each component may be configured to reside on an addressable storage medium or may be configured to reproduce one or more processors. As an example, components may include software components, object-oriented software components, class components, task components, processes, functions, properties, procedures, subroutines, segments of program code, drivers, firmware, microcode, circuits, data, databases, data structures, tables, arrays, and variables.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, the integrated component may perform one or more functions of each of the plurality of components in the same or similar manner as they are performed by the corresponding component of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An optical communication apparatus comprising:
a first optical system unit and a second optical system unit that allow light of at least one first wavelength to be transmitted into a free space and receive light of at least one second wavelength from the free space; and
a modulation module that provides data which is transmitted to the first and second optical system units,
wherein the first and second optical system units are arranged to control transmission/reception directions according to a communication target.

2. The optical communication apparatus of claim 1, wherein the first and second optical system units are attached to at least one gimbal unit, and
the transmission/reception directions are controlled according to movement of the at least one gimbal unit.

3. The optical communication apparatus of claim 1, further comprising a pointing, acquisition and tracking (PAT) unit,
wherein the PAT unit tracks at least one other optical communication apparatus that transmits/receives data to/from the first or second optical system unit and controls the transmission/reception direction of the first or second optical system unit to facilitate communication with the at least one other optical communication apparatus.

4. The optical communication apparatus of claim 3, wherein, when the other optical communication apparatus is a first optical communication apparatus and the first and second optical system units transmit/receive data to/from the first optical communication apparatus,
the transmission/reception directions of the first and second optical system units are each controlled to be a default direction toward the first optical communication apparatus and then finely controlled to facilitate communication with the first optical communication apparatus according to the tracking by the PAT unit.

5. The optical communication apparatus of claim 3, wherein when the other optical communication apparatuses are a first optical communication apparatus and a second optical communication apparatus and the first and second optical system units transmit data generated based on data received from the first optical communication apparatus to the second optical communication apparatus,
the transmission/reception directions of the first and second optical system units are each controlled to be a default direction toward the first and second optical communication apparatuses and then finely controlled to facilitate communication with the first and second optical communication apparatuses according to the tracking by the PAT unit.

6. The optical communication apparatus of claim 5, wherein the first and second optical system units relay the data received from the first optical communication apparatus to the second optical communication apparatus or transmit data obtained as a result of performing a designated operation based on the data received from the first optical communication apparatus to the second optical communication apparatus.

7. The optical communication apparatus of claim 1, wherein:
the modulation module provides first data to the first and second optical system units; and
the first and second optical system units transmit the first data sequentially or simultaneously.

8. The optical communication apparatus of claim 7, wherein the first and second optical system units receive at least one piece of second data from the other optical communication apparatus during, before, or after transmitting the first data.

9. The optical communication apparatus of claim 1, wherein:
the modulation module provides first data and second data to the first and second optical system units, respectively; and
the first and second optical system units transmit the first data and the second data sequentially or simultaneously.

10. The optical communication apparatus of claim 1, wherein the first and second optical system units receive at least one piece of third data during, before, or after transmitting the first data and the second data, respectively.

11. An optical communication method, which is performed by an optical communication apparatus including a first optical system unit and a second optical system unit that allow light of at least one wavelength to be transmitted/received and controls transmission/reception directions thereof, the optical communication method comprising:
identifying communication targets of the first and second optical system units; and
controlling the transmission/reception directions of the first and second optical system units to be different directions according to the identified communication targets.

12. The optical communication method of claim 11, wherein the controlling of the transmission/reception directions includes:
controlling the transmission/reception directions of the first and second optical system units to be default directions toward the communication targets; and
finely controlling the transmission/reception directions of the first and second optical system units according to a tracking result of the communication targets to facilitate communication with the communication targets.

13. The optical communication method of claim 11, wherein the controlling the transmission/reception directions includes controlling the transmission/reception directions of the first and second optical system units to face one optical communication apparatus when the communication target is the one optical communication apparatus.

14. The optical communication method of claim 11, wherein the controlling directions includes controlling the of the transmission/reception transmission/reception directions of the first and second optical system units to face a plurality of different optical communication apparatuses when the communication targets are the plurality of different optical communication apparatuses.

15. The optical communication method of claim 11, further comprising:
transmitting first data to the first and second optical system units; and
transmitting the first data through the first and second optical system units sequentially or simultaneously.

16. The optical communication method of claim 15, further comprising receiving at least one piece of second data from the other optical communication apparatus during, before, or after the first and second optical system units transmit the first data.

17. The optical communication method of claim 11, further comprising:
providing first data and second data to the first and second optical system units, respectively; and
transmitting, by the first and second optical system units, the first data and the second data sequentially or simultaneously.

18. The optical communication method of claim 17, further comprising receiving at least one piece of third data during, before, or after the first and second optical system units transmit the first data and the second data, respectively.

19. The optical communication method of claim 11, further comprising transmitting and receiving, by the first and second optical system units, different data after carrying the different data on light of at least one wavelength.

20. An optical communication apparatus comprising:
a first optical system unit;
a second optical system unit that transmits and receives an optical signal different from that of the first optical system unit; and
a gimbal unit that controls an angle between the first and second optical system units according to a communication target.
